(19) United States
(12) Patent Application Publication
(10) Pub. No.: US 2004/0234860 A1
(43) Pub. Date: Nov. 25, 2004

(54) Alkaline electrochemical cell having modified graphite additive

(76) Inventors: Deyang Qu, Madison, WI (US); Trevor Marshall, Oregon, WI (US); Ken Redding, Boscobel, WI (US); Tom Michaelis, Madison, WI (US); David Mihara, Madison, WI (US); Chris Garber, Lodi, WI (US)

Correspondence Address: QUARLES & BRADY LLP, 411 E. WISCONSIN AVENUE, SUITE 2040, MILWAUKEE, WI, 53202-4497, US

(21) Appl. No.: 10/444,189

(22) Filed: May 23, 2003

(51) Int. Cl. H01M 4/62; H01M 4/50

(52) U.S. Cl. 429/232; 429/224; 252/182.1

(57) ABSTRACT

An electrochemical cell is provided whose cathode includes a graphite mixture having regular graphite and modified graphite having an average surface area greater than that of the regular graphite. The modified graphite has an aspect ratio greater than or equal to 1.2, and may be present at a concentration less than 25% relative to the graphite mixture.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates generally to the fabrication of alkaline electrochemical cells, and in particular relates to the preparation of a cathode suitable for use in an electrochemical cell having expanded graphite additives.

Conventional electrochemical cells, such as alkaline cells, include a cathode that is often wetted with an alkaline electrolyte and compressed into annular rings. The cathode is then placed into a metal container, which then serves as the positive current collector. An anode, which generally comprises a powdered zinc disposed in a gel such as carboxymethylcellulose, is also placed into the metal container. A negative current collector, usually a brass pin or nail, is placed in electrical contact with the anode.

In order for the cell to operate properly, the electrolyte, typically a hydroxide, must be able to move freely between the anode and cathode. However, the anode and cathode must be electrically isolated from one another to prevent a short circuit that would cause cell failure. The electrolyte transfer and electrical isolation are conventionally achieved using an annular separator disposed at the interface between the anode and cathode. Separators typically comprise a non-woven, inert fabric having sufficient porosity to enable permeability to gas and liquid such as an electrolyte, while being sufficiently solid so as to prevent the cathode from electrically shorting with the anode. Alternatively, a conformal separator may be used.

It is known to include carbonaceous material, typically graphite, along with manganese dioxide, MnO₂, in the cathode. In particular, the overall discharge capacity of the cell increases as additional quantities of manganese dioxide are included in the cathode mixture. The carbonaceous material also enables adequate conductivity in the cathode. However, the material occupies cathode volume that manganese dioxide could otherwise occupy. It has thus become desirable to produce a cell having a reduced volume of graphite in the cathode without sacrificing cell conductivity.

Graphite may be fabricated in either an expanded form or a non-expanded form. Because expanded graphite has a greater surface area than non-expanded graphite, contact with the manganese dioxide particles is enhanced, thereby increasing conductivity in the cathode. The increased surface area of expanded graphite enables reducing the volume of graphite added to the cathode while still ensuring adequate conductivity. This provides additional cathode volume that can be occupied by manganese dioxide. Conventional cells thus employed pure expanded graphite in the cathode mix.

However, non-expanded graphite particles are less expensive to fabricate than expanded graphite. Accordingly, in order to achieve the in-cell advantages of implementing expanded graphite particles while minimizing the increased fabrication expense, it had become desirable to provide a mix of non-expanded graphite and expanded graphite particles in the cathode, while minimizing the quantity of expanded graphite to the extent possible without adversely affecting cell performance.

U.S. Pat. No. 6,451,486, for instance, discloses a cathode assembly that uses a blend of non-expanded graphite particles and expanded graphite particles in the cathode of a primary alkaline cell. The blend includes between 25% and 75% expanded graphite particles by weight, with the remaining particles being non-expanded graphite. This mixture is said to enable reducing the quantity of graphite added to the cathode, thereby creating additional cathode volume that may be occupied by manganese dioxide. The cell having this blend is said to achieve up to 98% of the performance of a control cell having only expanded graphite, thereby producing substantially the same performance as the control cell while reducing cost by including of non-expanded graphite particles into the blend.

However, because manganese dioxide is abrasive, the tooling suffers from increased wear during fabrication of such conventional cathodes. Furthermore, 25% expanded graphite occupies cathode volume that could otherwise be used for active manganese dioxide.

It would thus be desirable to further reduce the concentration of expanded graphite in the cathode mix without decreasing the conductivity of the cathode to realize the in-cell benefits of increased quantities of manganese dioxide in the cathode. It would be furthermore desirable to increase the quantity of manganese dioxide in the cathode while reducing wear on the fabrication tooling.

### SUMMARY OF THE INVENTION

In one aspect, a primary alkaline electrochemical cell includes an anode, a separator, and a cathode mixture including manganese dioxide and a graphite mixture. The graphite mixture includes regular graphite and modified graphite having an average surface area greater than that of the regular graphite. The modified graphite has a concentration of less than 25% by weight relative to the graphite mixture.

In another aspect, a primary alkaline electrochemical cell includes an anode, a separator, and a cathode mixture including manganese dioxide and a graphite mixture. The graphite mixture includes regular graphite and modified graphite having an average surface area greater than that of the regular graphite. At least 10% of the modified graphite has an aspect ratio not less than 1.2.

In another aspect, a primary alkaline electrochemical cell includes an anode, a separator, and a cathode mixture including manganese dioxide and a graphite mixture. The graphite mixture includes regular graphite and modified graphite having an average surface area greater than that of the regular graphite. The modified graphite particles are made of crystals having an average lateral distance between 700 and 900 Angstroms and a cumulative height between 500 and 850 Angstroms. The manganese dioxide and graphite are present at a ratio not less than 14:1.

In another aspect, a cathode usable in combination with a primary alkaline electrochemical cell includes a cathode mixture including manganese dioxide and a graphite mixture. The graphite mixture includes regular graphite and modified graphite having an average surface area greater than that of the regular graphite. The modified graphite has a concentration of less than 25% by weight relative to the graphite mixture.

In another aspect, a cathode usable in combination with a primary alkaline electrochemical cell includes a cathode mixture including manganese dioxide and a graphite mixture. The graphite mixture includes regular graphite and modified graphite having an average surface area greater than that of the regular graphite. At least 10% of the modified graphite has an aspect ratio not less than 1.2.

In another aspect, a cathode usable in combination with a primary alkaline electrochemical cell includes a cathode mixture including manganese dioxide and a graphite mixture. The graphite mixture includes regular graphite and modified graphite having an average surface area greater than that of the regular graphite. The modified graphite particles are made of crystals having an average lateral distance between 700 and 900 Angstroms and a cumulative height between 500 and 850 Angstroms. The manganese dioxide and graphite are present at a ratio not less than 14:1.

These and other aspects of the invention are not intended to define the scope of the invention for which purpose claims are provided. In the following description, reference is made to the accompanying drawings which form a part hereof, and which there is shown by way of illustration, and not limitation, preferred embodiments of the invention. Such embodiments do not define the scope of the invention and reference must therefore be made to the claims for this purpose.

### BRIEF DESCRIPTION OF THE DRAWINGS

FIG. 1 is a sectional side elevation view of an alkaline electrochemical cell;

FIG. 2 is a sectional side elevation view of a portion of a graphite crystal; and

FIG. 3 is a graph illustrating cell performance as a function of graphite additives.

### DETAILED DESCRIPTION OF THE PREFERRED EMBODIMENT

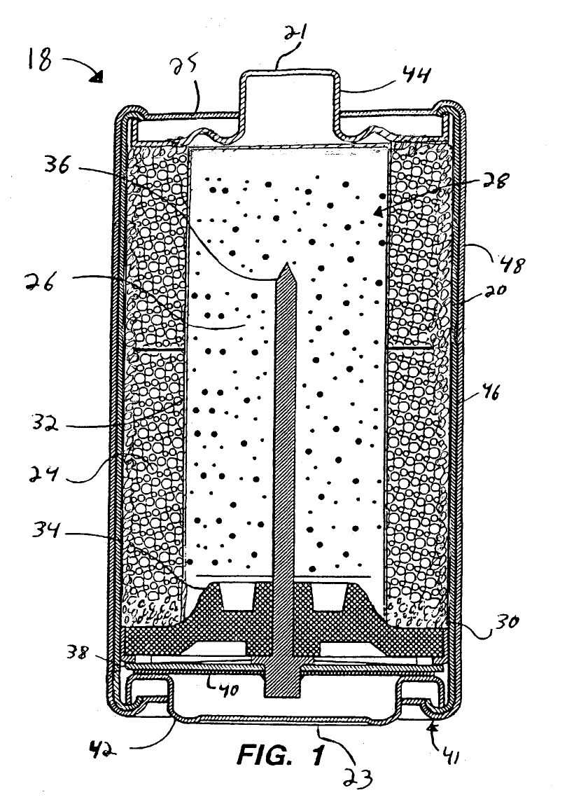

Referring to FIG. 1, an axially extending primary alkaline cylindrical cell 18 includes a positive terminal 21, a negative terminal 23, and a positive current collector in the form of an unplated cylindrical steel container 20. Container 20 is initially closed at its positive end 25 proximal the positive terminal 21 and open at its end proximal the negative terminal 23 such that the negative end of container is crimped to close the cell 18 as is understood generally by a skilled artisan. At least one or more cylindrical annular cathode rings 24, formed such that their outside diameters at their outer peripheral sidewalls are greater than the inside diameter of the positive current collector 20, are forced into the positive current collector. Installation of the cathode rings 24 forms a pressure contact with the can 20. Cathode 24 presents an inner surface 27 that define a centrally shaped void 28 in a cylindrical cell within which anode 26 is disposed.

A bead 30 is rolled into the container near the open end to support a sealing disk 34 as will be described below. Anode 26, which is placed inside of the cathode rings 24, is generally cylindrically shaped, and has an outer peripheral surface which engages the inner surfaces of a separator 32, and comprises gelled zinc in accordance with the preferred embodiment. Separator is disposed adjacent inner wall 27 between the cathode 24 and anode 26.

The sealing disk 34, having a negative current collector 36 extending therethrough, is placed into the open end of the container 20 and in contact with the bead 30. The negative open end 41 of the container 20 is crimped over the sealing disk 34 thus compressing it between the crimp and the bead 30 to close and seal the cell. An insulation washer 38 with a central aperture is placed over the crimped end of the cell such that the end of the negative current collector 36 protrudes through the aperture. A contact spring 40 is affixed to the end of the negative current collector 36. Negative terminal cap 42 and positive terminal cap 44 are placed into contact with the contact spring 40 and the positive current collector 20, respectively, and an insulating tube 46 and steel shell 48 are placed around the cell 18 and crimped on their ends to hold the terminal caps in place. It should be appreciated that steel shell 48 and insulating tube 46 could be eliminated to increase the internal volume for the cell that may be occupied by active ingredients. Such an arrangement is described in U.S. Pat. No. 5,814,419 assigned to Rayovac Corporation, the disclosure of which is hereby incorporated by reference herein for the purposes of background information. Rayovac primary alkaline cells having no steel shell 48 or insulating tube 46 are commercially identified as LR20 (size “D”) and LR14 (size “C”) type cells.

Separator 32 is most preferably an ionically permeable separator, and is interposed between anode 26 and the inner peripheral sidewalls of cathode rings 24 to prevent electrical contact between the anode and cathode while permitting ionic transport between anode 26 and the cathode 24. Separator further extends radially across the cell proximal the positive end and between the inner surface of the can 20 and the anode 26. An alkaline aqueous electrolyte typically comprising potassium hydroxide and water at least partially wets anode 26, cathode rings 24, and separator 32. The cell illustrated in FIG. 1 is not intended to limit the present invention, but rather to provide one example of an electrochemical cell that may be used in combination with the present invention, it being appreciated that several other cell constructions could alternatively be used.

The active component of cathode 24 is electrochemical manganese dioxide (EMD). Accordingly, as EMD is added to the cathode mix, the discharge capacity of the cell 18 is correspondingly increased. It should be appreciated that chemical manganese dioxide (CMD) may be alternatively used instead of or concurrently with EMD. Accordingly, the term “EMD” as used throughout this disclosure refers to EMD, CMD, or a combination of EMD and CMD. It should further be appreciated that the EMD/CMD may be purified if desired. As described above, it is known to use a blend of graphite particles having between 25% and 75% expanded graphite, with the remaining particles being non-expanded, or “regular” graphite.

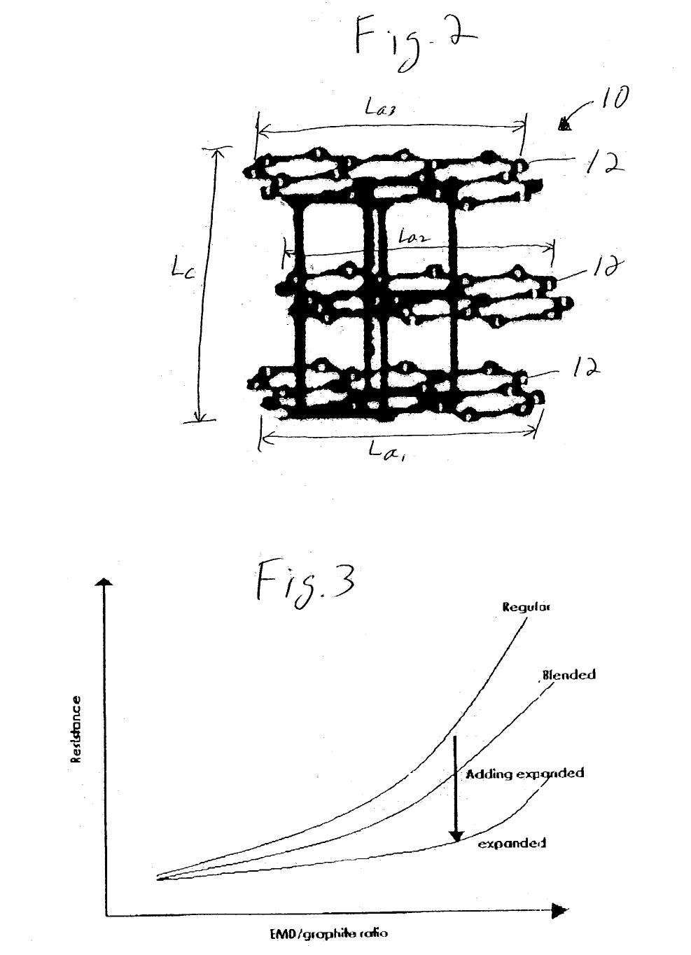

Referring to FIG. 2, a small portion of a graphite crystal 10 is illustrated and comprises a plurality of graphene layers 12 that are vertically stacked in a laterally staggered manner. Typically neighboring crystals are separated by a height of approximately 3.354 Angstroms. A typical crystal may comprise hundreds or even thousands of graphene layers 12, but only a few layers are shown for the purposes of illustration and clarity. Likewise, a graphite particle is made of several hundreds or thousands of graphite crystals. Non-expanded graphite particles are defined herein as those graphite particles whose crystals have graphene layers of an average lateral distance (La) between 900 and 1200 Angstroms, and a cumulative vertical height of all graphene layers (Lc) between approximately 850 and 1200 Angstroms. The non-expanded particles may be made either from natural or synthetic graphite.

The expanded, or modified, graphite particles are preferably fabricated by thermally expanding non-expanded graphite particles. The application of extreme heat to regular graphite produces air pockets in the graphite particles, and expands the particles to produce a larger surface area than regular graphite. Because thermal expansion also tends to break down the bonds between adjacent graphene layers, the crystal structure of expanded graphite particles is actually smaller than that of regular graphite particles. Expanded graphite particles are thus defined herein as those graphite particles whose crystals have graphene layers of an average lateral distance (La) between 700 and 900 Angstroms, and a cumulative vertical height for all graphene layers (Lc) between approximately 500 and 850 Angstroms.

While thermal expansion is used in accordance with the preferred embodiment to produce expanded graphite particles, one skilled in the art appreciates that other fabrication methods well known in the art, such as mechanical milling, may alternatively be used. The term “modified graphite” is intended to encompass all such fabrication methods, however, the term “expanded graphite” is used throughout this description for the purposes of clarity and convenience.

As described above, conventional expanded graphite is known to exhibit a higher conductivity and superior adhesion compared to regular graphite, as will be described in more detail below. In particular, referring to FIG. 3, cell resistance is highest when pure regular graphite is added to the cathode. As blended graphite is added (defined as a mixture of graphite particles including expanded and non-expanded particles), the cell resistance decreases, thereby illustrating the benefits of incorporating expanded graphite into the graphite mix. The conductivity of the cell continues to increase as expanded graphite is added to the graphite mixture. Furthermore, when expanded graphite is added to cathode 24, a reduced concentration of graphite in the cathode is attainable, thereby enabling a higher EMD/graphite ratio compared to cells using non-expanded graphite without decreasing the conductivity in the cathode 24. Conventional cells using expanded graphite have achieved a cathode having approximately 95% concentration of EMD relative to graphite.

In accordance with the present invention, the concentration of expanded graphite relative to the graphite mixture has been reduced, as has the concentration of graphite relative to the cathode mixture, without substantially sacrificing conductivity of the cathode. The graphite reduction provides additional cathode volume that may be occupied by EMD. This increases the ratio of EMD/graphite in the cathode and enables a higher cell capacity with respect to the prior art. Furthermore, because the concentration of expanded graphite in the graphite mixture is reduced, the cost of fabricating the cathode is also reduced. Specifically, the present invention includes a cathode mixture having expanded graphite particles whose crystals have an average expansion ratio (La/Lc) greater than or equal to 1.2. It should thus be appreciated that while some of the expanded particles have an aspect ratio less than 1.2 while others have an aspect ratio greater than 1.2, the average aspect ratio is not less than 1.2.

It should be appreciated that throughout this disclosure, the term “graphite mixture” refers to a mixture of expanded graphite and non-expanded graphite that is added to the cathode to produce a “cathode mixture” which is used herein to include the graphite mixture, and a quantity of EMD. In addition to manganese dioxide and graphite, cathode mixtures typically further include binders, such as polyethylene powders, polyacrylamides, Portland cement or fluorocarbon resins, such as PVDF and PTFE. However, as will be described in more detail below, the present invention reduces the need for, or eliminates altogether, the need for binding agents in the cathode mixture. The cathode mixture may include additional performance-enhancing additives, as is appreciated by those having ordinary skill in the art.

It has been found that expanded graphite particles having an aspect ratio at or above 1.2 exhibit superior conductivity compared to conventional expanded graphite particles. Accordingly, the concentration by weight of expanded graphite having an aspect ratio of 1.2 relative to the graphite mixture is reduced to a level less than 25%, and more preferably less than 20%. Preferred concentrations by weight of expanded graphite having an aspect ratio of 1.2 or greater relative to the graphite mixture are between 5% and 25%, and more preferably between 5% and 20%, and more preferably still between 5% and 15%. Other preferred concentrations by weight of expanded graphite having an aspect ratio of 1.2 or greater relative to the graphite mixture are between 10% and 25%, and more preferably between 15% and 25%. Still other preferred concentrations by weight of expanded graphite having an aspect ratio of 1.2 or greater relative to the graphite mixture are between 10% and 20%. It has been found that the reduced concentrations of expanded graphite compared to the prior art are attainable without sacrificing cell performance by including into the graphite mixture an expanded graphite having an aspect ratio (La/Lc) greater than or equal to 1.2. The remaining graphite in the graphite mix is non-expanded, or regular, and may be either synthetic or natural graphite.

It should further be appreciated that the benefits of the present invention may be realized without using a 1.2 aspect ratio for all expanded graphite particles as in the preferred embodiment of the present invention. The present invention thus contemplates a cathode with a concentration of expanded graphite particles having an average aspect ratio at or above 1.2 relative to the remaining expanded graphite in the cathode between and including 10% and 100%, including approximately 30%, 50%, and 75%, by weight.

Expanded graphite having an aspect ratio greater than 1.2 has a reduced crystal size and an increased number of crystals compared to conventional expanded graphite. Specifically, during thermal expansion, the crystals of graphite are broken down into smaller crystals, thereby reducing crystal size and increasing the number of crystals. As a result, the expanded graphite in accordance with the present invention has been found to become more evenly dispersed in the cathode mixture, thereby increasing the conductivity of the cathode 24 compared to cells using expanded graphite constructed in accordance with the prior art.

Accordingly, an increased EMD/graphite ratio is attainable in accordance with the present invention without sacrificing conductivity in the cathode 24. Specifically, the present invention realizes an EMD/graphite ratio, by weight, greater than 14:1, and preferably the range of 14:1 and 24:1, and more preferably between the range of 16:1 and 20:1, and more preferably still approximately 18:1. These EMD/graphite ratios are greater than what was conventionally attainable. Because manganese dioxide is the active cathode ingredient, the increased EMD/graphite ratios yield a higher discharge capacity for an electrochemical cell compared to conventional cells.

Furthermore, it has been found as an unexpected result that expanded graphite with an aspect ratio of 1.2 or greater has more outer valence electrons after completion of the expansion process. As described above, the expanded graphite particles thus tend to adhere to each other through the excess Van der Walls force from the graphene layers that are split during expansion. Thus the increased binding force achieved using expanded graphite in accordance with the present invention advantageously reduces or eliminates altogether the need to add a binding agent to the cathode mix. It has been found that only a small amount (within the ranges discussed above) of expanded graphite with an aspect ratio of 1.2 or greater is needed to ensure sufficient cathode integrity at the high EMD/graphite ratios described above.

It has also been found that turbostratic disorders of expanded graphite created during thermal expansion are greater than those associated with regular graphite. High turbostratic disorders have been found to reduce graphite lubricity. However, the negative impact of the turbostratic disorders is offset or minimized by the greater aspect ratio (i.e., greater than or equal to 1.2) of the expanded graphite in accordance with the preferred embodiment. Generally, it has been discovered that lubricity increases with increasing aspect ratios. Furthermore, because the present invention minimizes the concentration of expanded graphite, and because the expanded graphite of the present invention has higher lubricity than conventional expanded graphite, the lubricity of the overall cathode mixture is increased. Accordingly, by blending less than 25%, and preferably less than 20% of expanded graphite with regular graphite, the tool life is improved. Furthermore, because expanded graphite is more expensive to produce than regular graphite, the present invention also reduces the fabrication cost.

While the expanded graphite has an aspect ratio greater than or equal to 1.2 in accordance with the preferred embodiment, it should be appreciated that advantages may also be attained using expanded graphite having a greater aspect ratio, for example not less than 1.5, or not less than 2.0.

### EXAMPLES

The following examples are provided to further illustrate the advantages of various principles of various embodiments of the present invention, it being appreciated that the invention is not limited by any of the examples, but is rather to be broadly construed as described above.

### Example 1

Two size LR20 cells were tested whose cathodes included a graphite mixture comprised of 20% expanded graphite with an aspect ratio of 1.2 or greater mixed with 80% regular natural graphite. The total amount of graphite and manganese dioxide added to the cathode were controlled such that the first cell had an EMD/graphite ratio of 14:1, while the second cell had an EMD/graphite ratio of 16:1. The cells were tested against a control cell, which included pure synthetic regular graphite at an EMD/graphite ratio of 11:1.

Specifically, referring to Table 1, the cells were tested on the 1.5 ohm ANSI Heavy Industrial Flashlight Test (HIFT: 4 minute discharge every 15 minutes over an eight hour period, repeated daily) until the 0.65 CCV endpoint was reached. The cells were also tested at a 2.2 ohm continuous discharge for 1 hour/day (repeated daily) until the ANSI end point was reached, and also at a 10 ohm continuous discharge for 4 hours/day (repeated daily) until the ANSI end point was reached.

As illustrated in Table 1, the first test cell having a 14:1 EMD/graphite ratio exhibited superior discharge performance compared to the control cell, while the second test cell having a 16:1 ratio outperformed the first test cell in all tests. Example 1 thus indicates that cell performance increases with higher EMD/graphite ratios.

TABLE 1

| | 1.5 ohm HIFT | 2.2 ohm 1 H/D | 10 ohm 4 H/D |
|---|---|---|---|
| EMD/graphite ratio | end @ 0.9 V | end @ 0.9 V | end @ 0.9 V |
| 14:1 | 110% | 110.8% | 106.3% |
| 16:1 | 111.4% | 114.3% | 108.6% |

### Example 2

A size LR20 cell was tested whose cathode included a graphite mixture comprised of 15% expanded graphite with an aspect ratio of 1.2 or greater mixed with 85% regular natural graphite. The cell had an EMD/graphite ratio of 14:1. The cell was tested using the HIFT and hours/day tests described above with reference to Example 1, and compared to a control cell having pure synthetic regular graphite at an EMD/graphite ratio of 11:1. Referring to Table 2, the test results indicate that the concentration of expanded graphite of the present invention may be further reduced from 20% to 15% while still exhibiting improved discharge performance over conventional cells. Furthermore, the test cell in Example 2 outperformed the first test cell (with the same EMD/graphite ratio) in Example 1 in the 10 ohm 4 hour/day test.

TABLE 2

| | 1.5 ohm HIFT | 2.2 ohm 1 H/D | 10 ohm 4 H/D |
|---|---|---|---|
| EMD/graphite ratio | end @ 0.9 V | end @ 0.9 V | end @ 0.9 V |
| 14:1 | 105.7% | 105.4% | 108.5% |

### Example 3

Two size LR20 cells were provided, each having different expanded graphite concentrations relative to the graphite mixture. The first cell cathode included a graphite mixture of 10% expanded graphite, while the second cell cathode included a graphite mixture of 15% expanded graphite (the expanded graphite in each cell having an aspect ratio of 1.2 or greater. Referring to Table 3, the cells were continuously discharged at 10 ohms for 4 hours/day (repeated daily) until the ANSI end point was reached. Both cells outperformed the control cell having a cathode having an EMD/graphite ratio of 11:1, and whose graphite mixture included pure synthetic regular graphite. This example illustrates that the expanded graphite of the present invention may be present at a concentration as low as 10% relative to the graphite mix while exhibiting improved discharge performance over conventional cells.

TABLE 3

Expanded Graphite %

| | 10 | 15 |
|---|---|---|
| 10 ohm 4 H/D | 103.6% | 102.6% |
| end @ 0.9 V | | |

### Example 4

Two size LR6 cells were tested whose cathodes included graphite mixtures of 20% expanded graphite having an aspect ratio of 1.2 or greater mixed with 80% natural regular graphite. The overall quantities of graphite and manganese dioxide were controlled such that the first cell had an EMD/graphite ratio of 16:1, while the second cell had an EMD/graphite ratio of 18:1.

Referring to Table 4, the cells were stored for 2 weeks at 130° F. and subsequently subjected to four tests. In the first test, the cells were continuously discharged at 3.9 ohms for 1 hour/day (repeated daily) until the cell discharge reached the ANSI end point. In the second test, the cells were continuously discharged at 10 ohms for 1 hour/day (repeated daily) until the cell discharge reached the ANSI end point. In the third test, the cells were continuously discharged at 1 ampere until reaching the ANSI end point. In the fourth test, the cells were continuously discharged at 250 milli-amps for 1 hour/day (repeated daily) until reaching the ANSI end point. The test results were compared to a control cell having and EMD/graphite ratio of 11:1 and a graphite mixture including pure synthetic regular graphite. Example 4 illustrates that increased EMD/graphite ratios enable enhanced cell performance under conditions of both continuous and intermittent discharge.

TABLE 4

| EMD/ | | | | |
|---|---|---|---|---|
| Graphite | 3.9 ohm 1 H/D | 10 ohm 1 H/D | 1 A Cont. | 250 mA 1 H/D |
| Ratio | end @ 0.8 V | 0.9 V | 1.0 V | 0.9 V |
| 16:1 | 100.8% | 101.4% | 124.4% | 103.1% |
| 18:1 | 102.4% | 103.8% | 111.9% | 100.9% |

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

I claim:

1. A primary alkaline electrochemical cell, comprising:
a cathode mixture including manganese dioxide and a graphite mixture, wherein the graphite mixture includes quantities of regular graphite and modified graphite having an average surface area that is greater than the that of the regular graphite, and wherein the modified graphite has a concentration of less than 25% by weight relative to the graphite mixture;
an anode;
a separator; and
an alkaline electrolyte.

2. The primary alkaline electrochemical cell as recited in claim 1, wherein the concentration of modified graphite is between 5% and 25%.

3. The primary alkaline electrochemical cell as recited in claim 2, wherein the concentration of modified graphite is between 10% and 25%.

4. The primary alkaline electrochemical cell as recited in claim 3, wherein the concentration of modified graphite is between 15% and 25%.

5. The primary alkaline electrochemical cell as recited in claim 1, wherein the concentration of modified graphite is less than 20%.

6. The primary alkaline electrochemical cell as recited in claim 5, wherein the concentration of modified graphite is between 5% and 20%.

7. The primary alkaline electrochemical cell as recited in claim 6, wherein the concentration of modified graphite is between 10% and 20%.

8. The primary alkaline electrochemical cell as recited in claim 1, wherein at least 10% of the modified graphite includes graphite particles having an aspect ratio not less than 1.2.

9. The primary alkaline electrochemical cell as recited in claim 8, wherein at least 30% of the modified graphite includes graphite particles having an aspect ratio not less than 1.2.

10. The primary alkaline electrochemical cell as recited in claim 9, wherein at least 50% of the modified graphite includes graphite particles having an aspect ratio not less than 1.2.

11. The primary alkaline electrochemical cell as recited in claim 8, wherein at least 10% of the modified graphite includes graphite particles having an aspect ratio not less than 1.5.

12. The primary alkaline electrochemical cell as recited in claim 1, wherein at least 75% of the modified graphite includes graphite particles having an aspect ratio not less than 1.2.

13. The primary alkaline electrochemical cell as recited in claim 1, wherein substantially all of the modified graphite has an aspect ratio not less than 1.2.

14. The primary alkaline electrochemical cell as recited in claim 1, wherein the manganese dioxide and graphite mixture are present at a ratio greater than 14:1.

15. A primary alkaline electrochemical cell, comprising:
a cathode mixture including manganese dioxide and a graphite mixture, wherein the graphite mixture includes regular graphite and modified graphite having an average surface area greater than that of the regular graphite, wherein at least 10% of the modified graphite has an aspect ratio not less than 1.2;
an anode;
a separator; and
an alkaline electrolyte.

16. The primary alkaline electrochemical cell as recited in claim 15, wherein at least 30% of the modified graphite includes graphite particles having an aspect ratio not less than 1.2.

17. The primary alkaline electrochemical cell as recited in claim 16, wherein at least 50% of the modified graphite includes graphite particles having an aspect ratio not less than 1.2.

18. The primary alkaline electrochemical cell as recited in claim 15, wherein at least 10% of the modified graphite includes graphite particles having an aspect ratio not less than 1.5.

19. The primary alkaline electrochemical cell as recited in claim 15, wherein at least 75% of the modified graphite includes graphite particles having an aspect ratio not less than 1.2.

20. The primary alkaline electrochemical cell as recited in claim 15, wherein substantially all of the modified graphite has an aspect ratio not less than 1.2.

21. The primary alkaline electrochemical cell as recited in claim 15, wherein the modified graphite has a concentration of less than 25% by weight relative to the graphite mixture.

22. The primary alkaline electrochemical cell as recited in claim 15, wherein the concentration of modified graphite is between 5% and 25%.

23. The primary alkaline electrochemical cell as recited in claim 22, wherein the concentration of modified graphite is between 10% and 25%.

24. The primary alkaline electrochemical cell as recited in claim 23, wherein the concentration of modified graphite is between 15% and 25%.

25. The primary alkaline electrochemical cell as recited in claim 15, wherein the concentration of modified graphite is less than 20%.

26. The primary alkaline electrochemical cell as recited in claim 25, wherein the concentration of modified graphite is between 5% and 20%.

27. The primary alkaline electrochemical cell as recited in claim 26, wherein the concentration of modified graphite is between 10% and 20%.

28. A primary alkaline electrochemical cell, comprising:
a cathode mixture including manganese dioxide and a graphite mixture, wherein the graphite mixture includes regular graphite particles and modified graphite particles that are made of crystals having an average lateral distance between 700 and 900 Angstroms and a cumulative height between 500 and 850 Angstroms, and wherein the manganese dioxide and graphite are present at a ratio not less than 14:1;
an anode;
a separator; and
an alkaline electrolyte.

29. The primary alkaline electrochemical cell as recited in claim 28, wherein the ratio is between 14:1 and 24:1.

30. The primary alkaline electrochemical cell as recited in claim 29, wherein the ratio is between 16:1 and 20:1.

31. A cathode usable in combination with a primary alkaline electrochemical cell, comprising:
a cathode mixture including manganese dioxide and a graphite mixture, wherein the graphite mixture includes regular graphite and modified graphite having an average surface area greater than that of the regular graphite, and wherein the modified graphite has a concentration of less than 25% by weight relative to the graphite mixture.

32. The cathode as recited in claim 31, wherein the concentration of modified graphite is between 5% and 25%.

33. The cathode as recited in claim 32, wherein the concentration of modified graphite is between 10% and 25%.

34. The cathode as recited in claim 33, wherein the concentration of modified graphite is between 15% and 25%.

35. The cathode as recited in claim 31, wherein the concentration of modified graphite is less than 20%.

36. The cathode as recited in claim 35, wherein the concentration of modified graphite is between 5% and 20%.

37. The cathode as recited in claim 36, wherein the concentration of modified graphite is between 10% and 20%.

38. The cathode as recited in claim 31, wherein at least 10% of the modified graphite includes graphite particles having an aspect ratio not less than 1.2.

39. The cathode as recited in claim 38, wherein at least 30% of the modified graphite includes graphite particles having an aspect ratio not less than 1.2.

40. The cathode as recited in claim 39, wherein at least 50% of the modified graphite includes graphite particles having an aspect ratio not less than 1.2.

41. The cathode as recited in claim 38, wherein at least 10% of the modified graphite includes graphite particles having an aspect ratio not less than 1.5.

42. The cathode as recited in claim 31, wherein at least 75% of the modified graphite includes graphite particles having an aspect ratio not less than 1.2.

43. The cathode as recited in claim 31, wherein substantially all of the modified graphite has an aspect ratio not less than 1.2.

44. The cathode as recited in claim 31, wherein the manganese dioxide and graphite mixture are present at a ratio greater than 14:1.

45. A cathode usable in combination with a primary alkaline electrochemical cell, comprising:
a cathode mixture including manganese dioxide and a graphite mixture, wherein the graphite mixture includes regular graphite and modified graphite having an average surface area greater than that of the regular graphite, wherein at least 10% of the modified graphite has an aspect ratio not less than 1.2.

46. The cathode as recited in claim 45, wherein at least 30% of the modified graphite includes graphite particles having an aspect ratio not less than 1.2.

47. The cathode as recited in claim 46, wherein at least 50% of the modified graphite includes graphite particles having an aspect ratio not less than 1.2.

48. The cathode as recited in claim 45, wherein at least 10% of the modified graphite includes graphite particles having an aspect ratio not less than 1.5.

49. The cathode as recited in claim 45, wherein at least 75% of the modified graphite includes graphite particles having an aspect ratio not less than 1.2.

50. The cathode as recited in claim 45, wherein substantially all of the modified graphite has an aspect ratio not less than 1.2.

51. The cathode as recited in claim 45, wherein the modified graphite has a concentration of less than 25% by weight relative to the graphite mixture.

52. The cathode as recited in claim 45, wherein the concentration of modified graphite is between 5% and 25%.

53. The cathode as recited in claim 52, wherein the concentration of modified graphite is between 10% and 25%.

54. The cathode as recited in claim 53, wherein the concentration of modified graphite is between 15% and 25%.

55. The cathode as recited in claim 45, wherein the concentration of modified graphite is less than 20%.

56. The cathode as recited in claim 55, wherein the concentration of modified graphite is between 5% and 20%.

57. The cathode as recited in claim 56, wherein the concentration of modified graphite is between 10% and 20%.

58. A cathode usable in combination with primary alkaline electrochemical cell, comprising:
a cathode mixture including manganese dioxide and a graphite mixture, wherein the graphite mixture includes regular graphite particles and modified graphite particles having an average surface area greater than that of the regular graphite particles, and wherein the modified graphite particles are made of crystals having an average lateral distance between 700 and 900 Angstroms and a cumulative height between 500 and 850 Angstroms, and wherein the manganese dioxide and graphite are present at a ratio not less than 14:1.

59. The cathode as recited in claim 58, wherein the ratio is between 14:1 and 24:1.

60. The cathode as recited in claim 59, wherein the ratio is between 16:1 and 20:1.
